(19) United States
(12) Patent Application Publication
(10) Pub. No.: US 2025/0334146 A1
(43) Pub. Date: Oct. 30, 2025

(54) ELECTRONIC DEVICE

(71) Applicant: COMPAL ELECTRONICS, INC., Taipei City (TW)

(72) Inventors: Chien-Feng Chan, Taipei City (TW); Ming-Cheng Tsou, Taipei City (TW)

(73) Assignee: COMPAL ELECTRONICS, INC., Taipei City (TW)

(21) Appl. No.: 19/090,418

(22) Filed: Mar. 26, 2025

Related U.S. Application Data
(60) Provisional application No. 63/640,207, filed on Apr. 30, 2024.

(51) Int. Cl. F16C 11/04

(52) U.S. Cl. CPC F16C 11/04

(57) ABSTRACT

An electronic device includes a first body, a second body and a hinge module. The hinge module includes a base, a first sliding member, a rotating shaft and a second sliding member. The base has a first guiding slot. The first sliding member is slidably disposed on the base and has a second guiding slot. The rotating shaft is pivotally connected to the first sliding member. The rotating shaft is connected to the second body and has a third guiding slot. The second sliding member is slidably disposed in the first to third guiding slots. When the rotating shaft pivots, the second and third guiding slots guide the second sliding member to move on the first sliding member, and the first guiding slot guides the second sliding member, the first sliding member, the

### CROSS-REFERENCE TO RELATED APPLICATION

This application claims the priority benefit of U.S. provisional application Ser. No. 63/640,207, filed on Apr. 30, 2024. The entirety of the above-mentioned patent application is hereby incorporated by reference herein and made a part of this specification.

### BACKGROUND

### Technical Field

The disclosure relates to an electronic device, and in particular relates to an electronic device including a hinge module.

### Description of Related Art

As the performance of laptops continues to improve, the demand for heat dissipation efficiency has increased significantly. However, due to the trend of thinner and lighter designs of laptops, it is difficult to install a heat dissipation module of sufficient size in the body of a laptop, resulting in insufficient heat dissipation efficiency.

### SUMMARY

An electronic device with good heat dissipation efficiency is provided in the disclosure.

An electronic device of the disclosure includes a first body, a second body and a hinge module. The hinge module includes a base, a first sliding member, a rotating shaft, and a second sliding member. The base is disposed on the first body and has a first guiding slot. The first sliding member is slidably disposed on the base along a first axial direction and has a second guiding slot. The rotating shaft is pivotally connected to the first sliding member along a second axial direction and connected to the second body. The rotating shaft has a third guiding slot. The first guiding slot is inclined to the first axial direction and the second axial direction, the second guiding slot is parallel to the second axial direction, and the third guiding slot is inclined to the first axial direction and the second axial direction. The second sliding member is slidably disposed in the first guiding slot, the second guiding slot, and the third guiding slot. When the second body is flipped relative to the first body to pivot the rotating shaft, the second guiding slot and the third guiding slot guide the second sliding member to move on the first sliding member along the second axial direction, and the first guiding slot guides the second sliding member, the first sliding member, the rotating shaft and the second body to move together on the base along the first axial direction.

In an embodiment of the disclosure, the second sliding member has a first sliding portion and a second sliding portion. The first sliding portion is slidably disposed in the first guiding slot and the second guiding slot, and the second sliding portion is slidably disposed in the third guiding slot.

In one embodiment of the disclosure, the first guiding slot and the second guiding slot partially overlap each other, and the first sliding portion is disposed at an overlapping portion of the first guiding slot and the second guiding slot in a penetrating way.

In an embodiment of the disclosure, the first axial direction and the second axial direction are perpendicular to each other.

In one embodiment of the disclosure, the base has at least one fourth guiding slot. The at least one fourth guiding slot is parallel to the first axial direction, and the first sliding member is slidably disposed in the at least one fourth guiding slot.

In one embodiment of the disclosure, the hinge module further includes at least one rail, and the first sliding member is slidably disposed on the base along the first axial direction through the at least one rail.

In one embodiment of the disclosure, the second sliding member, the first sliding member, the rotating shaft, and the second body are adapted to move together along a direction toward a front end of the first body as the second body is unfolded relative to the first body.

In one embodiment of the disclosure, an inclination angle of the first guiding slot relative to the first axial direction and the second axial direction is 45 degrees.

In one embodiment of the disclosure, the first body has at least one heat dissipation region. The second sliding member, the first sliding member, the rotating shaft, and the second body are adapted to move as the second body is unfolded relative to the first body to expose the at least one heat dissipation region.

In one embodiment of the disclosure, the hinge module further includes at least one torsion element, and the at least one torsion element is disposed between the rotating shaft and the first sliding member.

Based on the above, in the electronic device of the embodiment of the disclosure, the rotating shaft of the hinge module may guide the second sliding member to move along the second axial direction through its inclined third guiding slot. When the second sliding member moves along the second axial direction, the second sliding member, the first sliding member, the rotating shaft and the second body may be guided to move on the base along the first axial direction together through the combination of the non-inclined second guiding slot of the first sliding member and the inclined first guiding slot of the base. Accordingly, when the user closes the second body to the first body, the second body and the hinge module cover the heat dissipation holes in the heat dissipation region of the first body to prevent dust and other foreign objects from falling into the heat dissipation holes. Furthermore, when the user unfolds the second body relative to the first body, the rotating shaft and the second body are displaced accordingly to expose the heat dissipation region on the first body, thereby greatly increasing the heat dissipation efficiency of the electronic device. Furthermore, in the hinge module of the embodiment of the disclosure, the second sliding member is guided by the third guiding slot of the rotating shaft as described above, and is guided by the combination of the second guiding slot of the first sliding member and the first guiding slot of the base, so that the second sliding member is directly connected to the base, the first sliding member and the rotating shaft through the first guiding slot, the second guiding slot and the third guiding slot respectively, so as to improve the overall actuation stability, wear resistance, actuation accuracy, structural strength and vibration resistance of the hinge module.

### BRIEF DESCRIPTION OF THE DRAWINGS

FIG. 1 is a schematic diagram of an electronic device of an embodiment of the disclosure.

FIG. 2 is a partial side view of the electronic device of FIG. 1.

FIG. 3 shows the second body of FIG. 2 unfolded relative to the first body.

FIG. 4A to FIG. 4D are three-dimensional diagrams of the actuation process of the hinge module of FIG. 2.

FIG. 5A to FIG. 5D are three-dimensional diagrams of the hinge module of FIG. 4A to FIG. 4D respectively at different viewing angles.

FIG. 6A to FIG. 6D are three-dimensional diagrams of the hinge module of FIG. 4A to FIG. 4D respectively at different viewing angles.

FIG. 7 is an exploded diagram of some components of the hinge module of FIG. 2.

### DETAILED DESCRIPTION OF DISCLOSED EMBODIMENTS

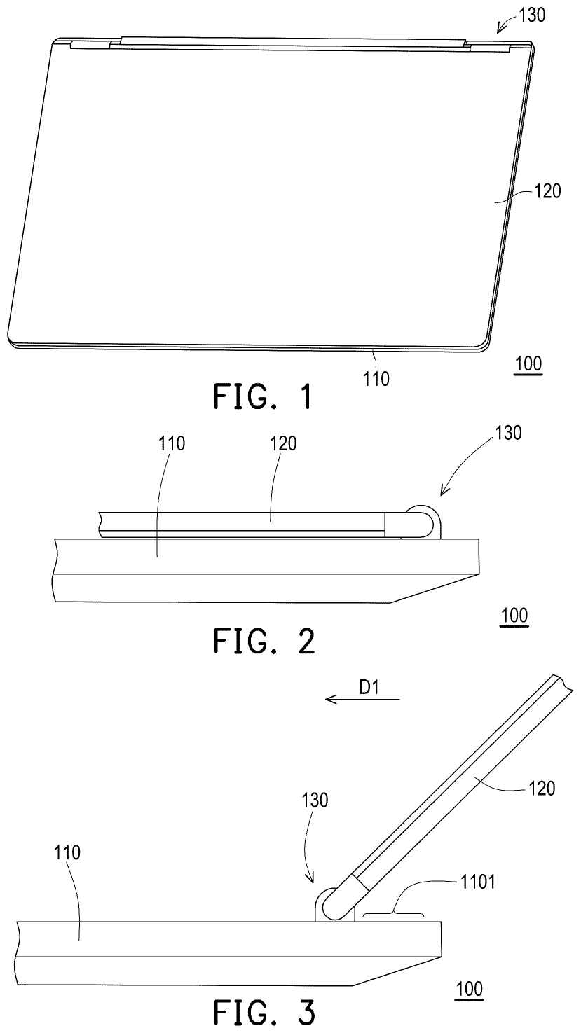

FIG. 1 is a schematic diagram of an electronic device of an embodiment of the disclosure. FIG. 2 is a partial side view of the electronic device of FIG. 1. FIG. 3 shows the second body of FIG. 2 unfolded relative to the first body. Referring to FIG. 1 to FIG. 3, the electronic device 100 of this embodiment is, for example, a laptop, and includes a first body 110, a second body 120, and a hinge module 130. The first body 110 is, for example, a host of a laptop, and the second body 120 is, for example, a screen of the laptop and is pivotally connected to the first body 110 through the hinge module 130. When the second body 120 is unfolded relative to the first body 110 as shown in FIG. 2 and FIG. 3, the second body 120 and the hinge module 130 are translated along the direction DI to expose the heat dissipation region 1101 on the first body 110. The heat dissipation region 1101 has, for example, heat dissipation holes for allowing heat dissipation airflow to pass through.

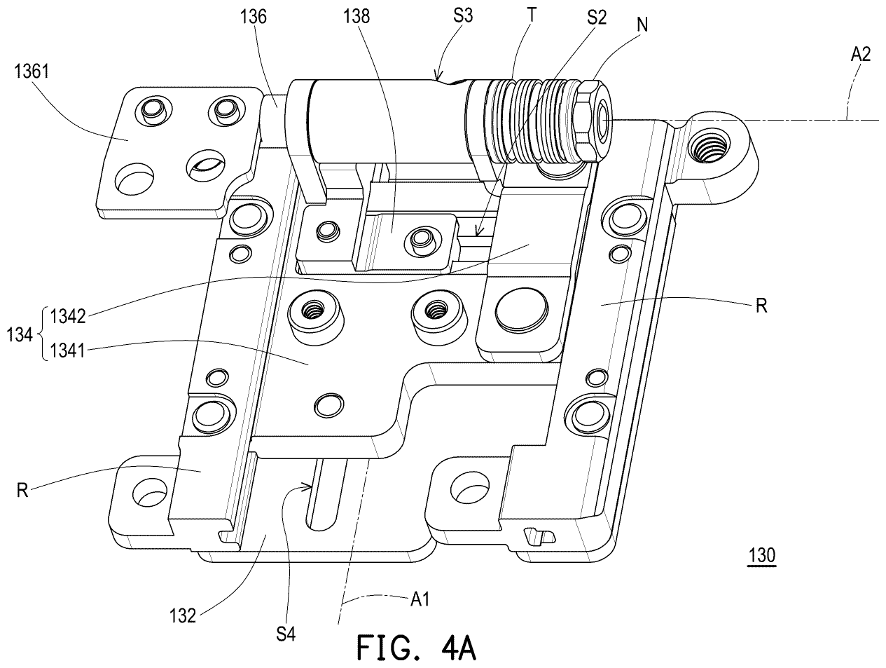

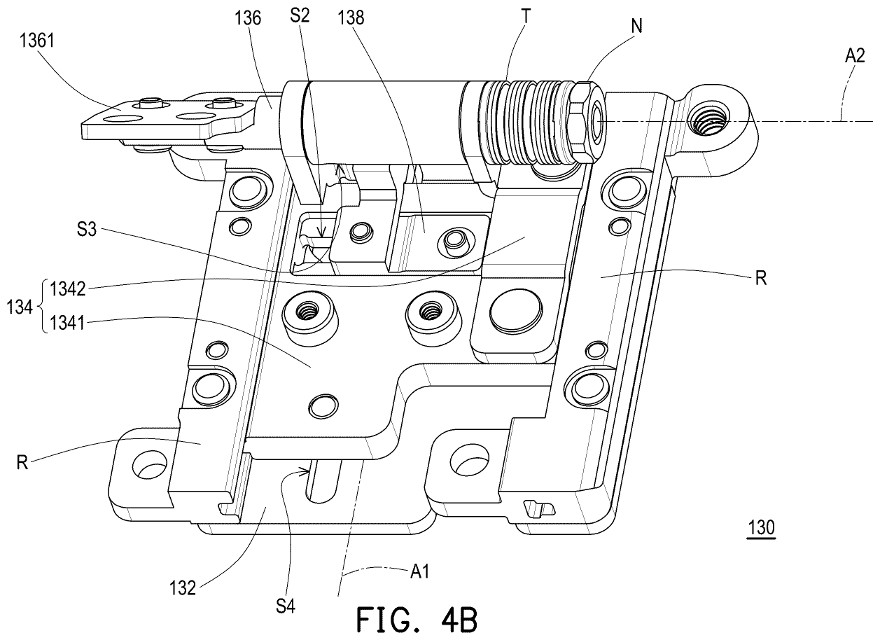

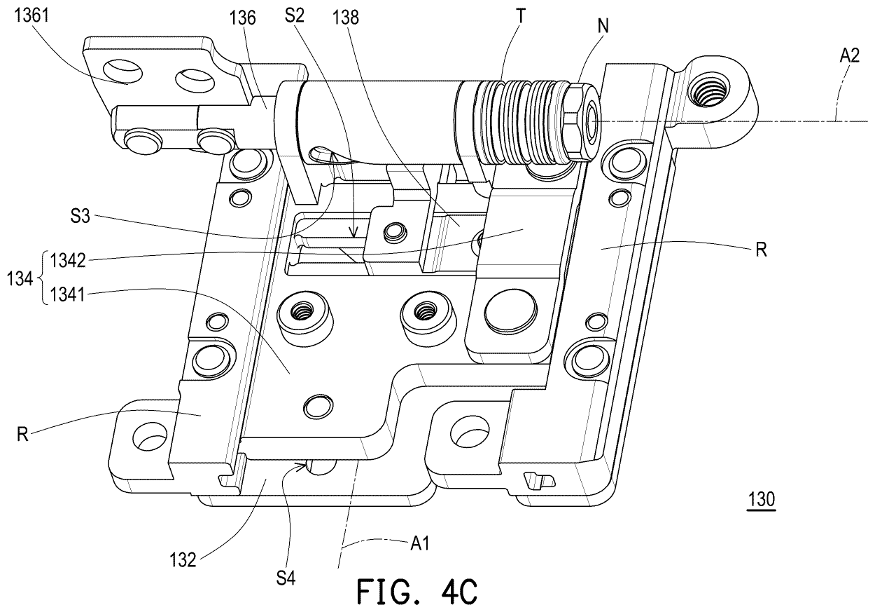

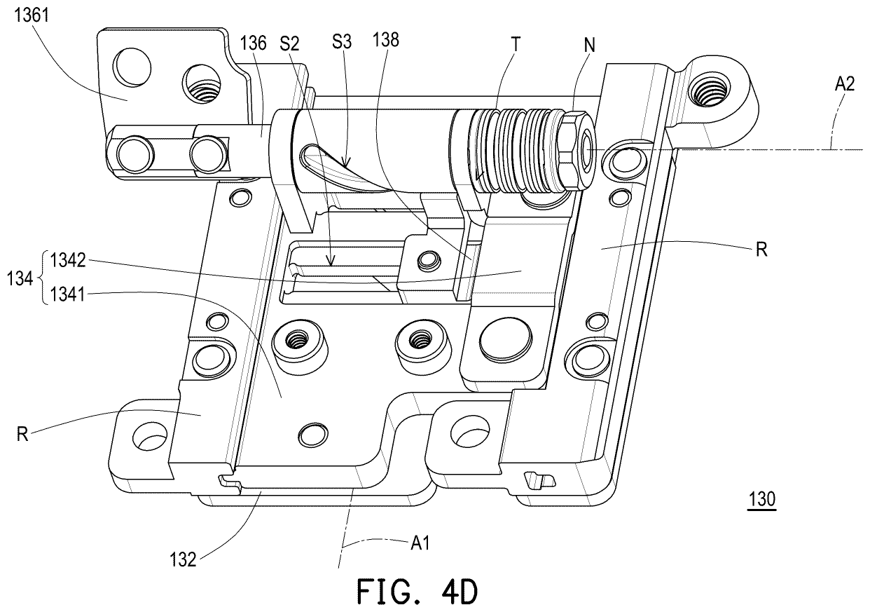

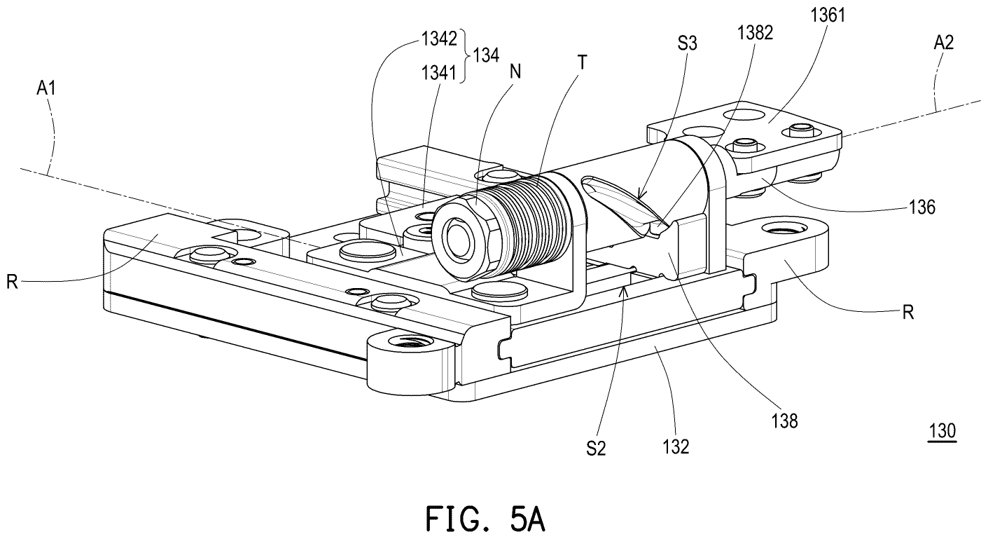

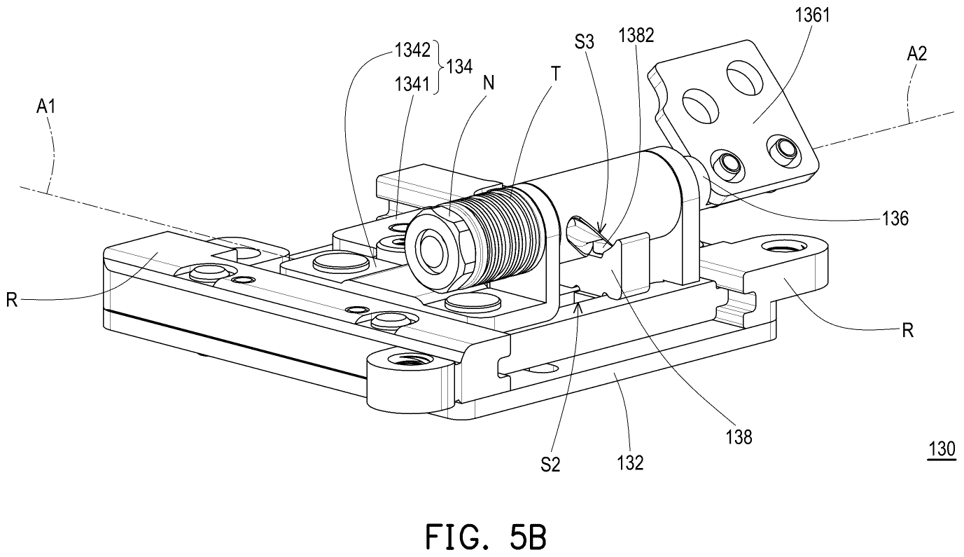

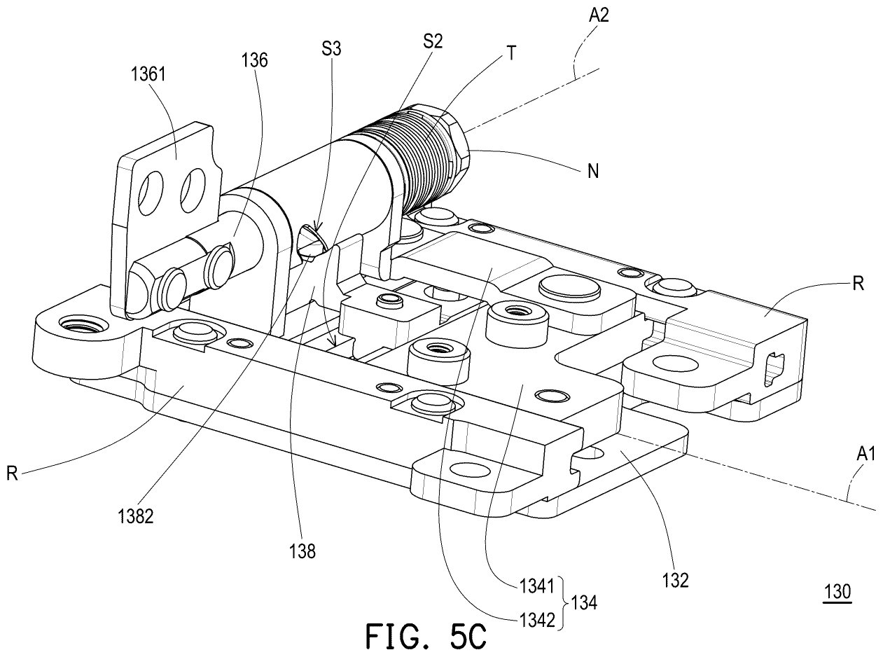

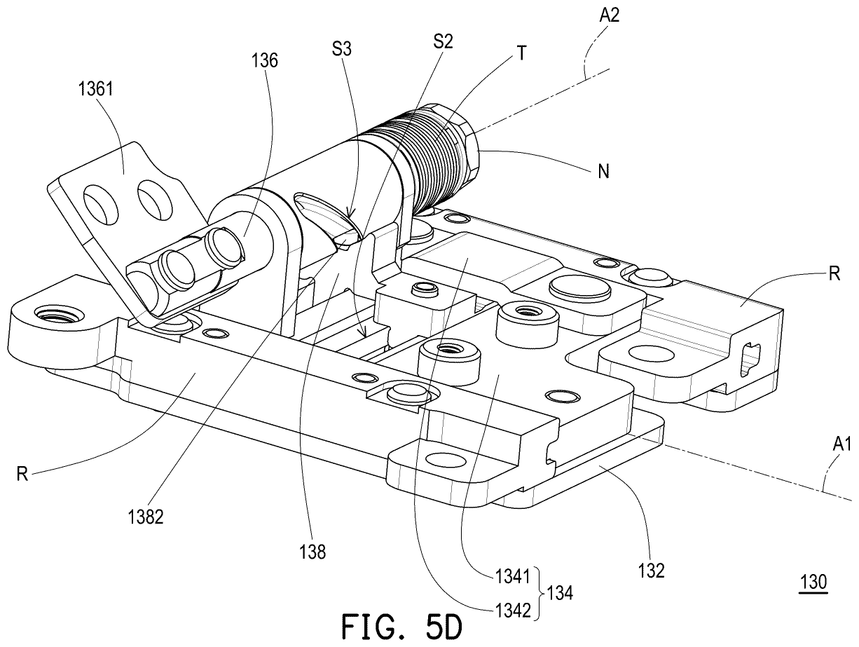

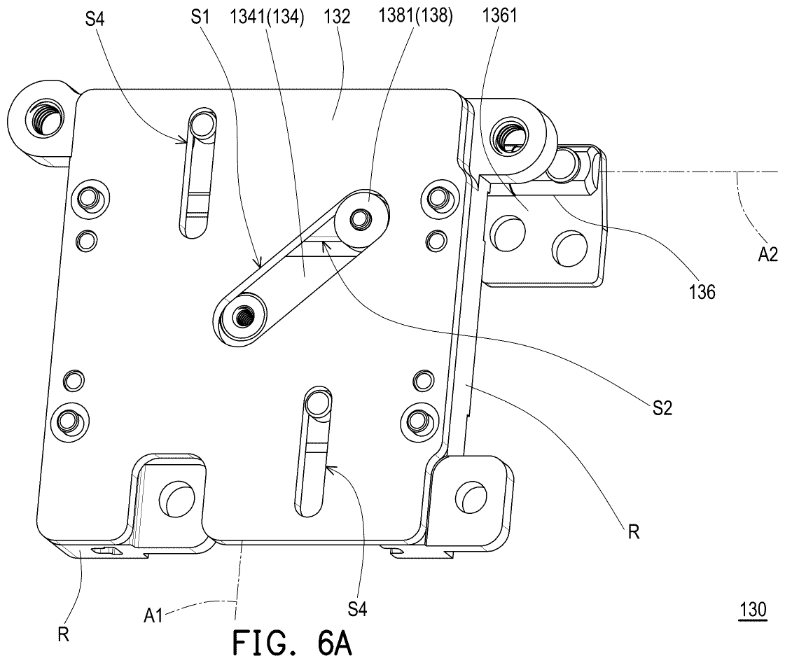

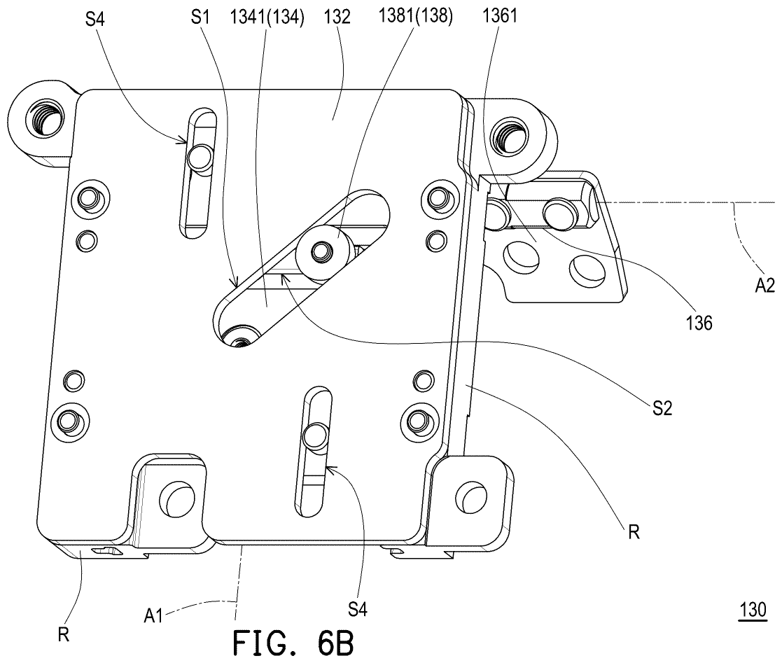

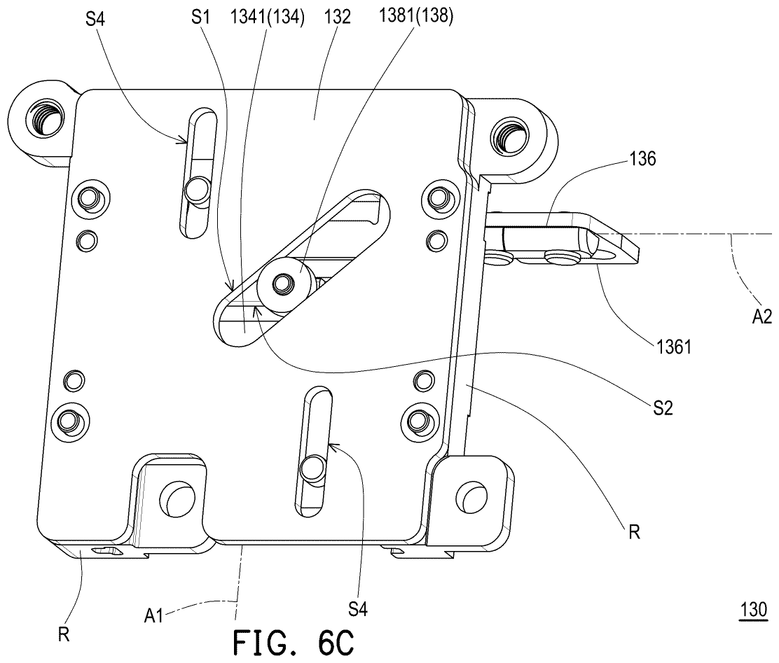

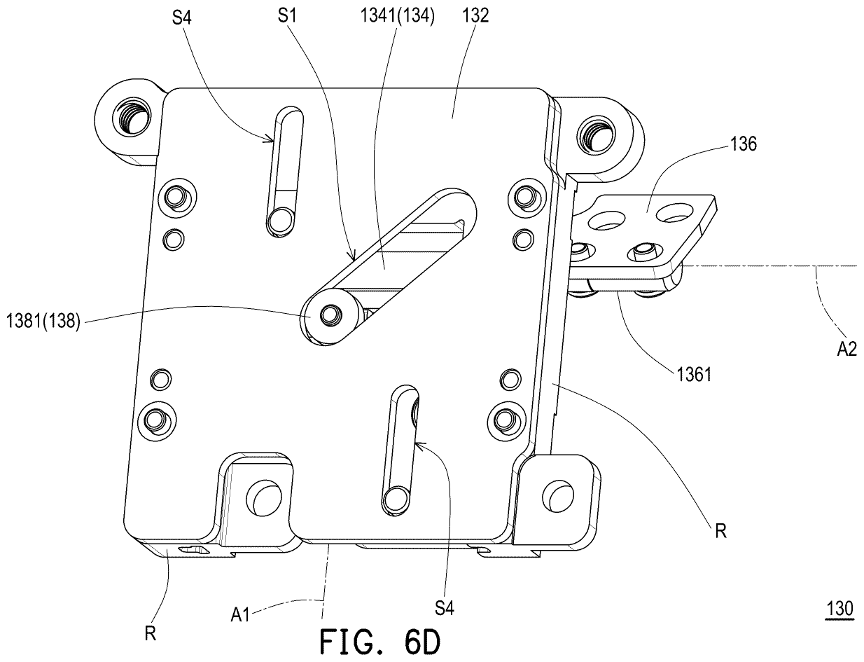

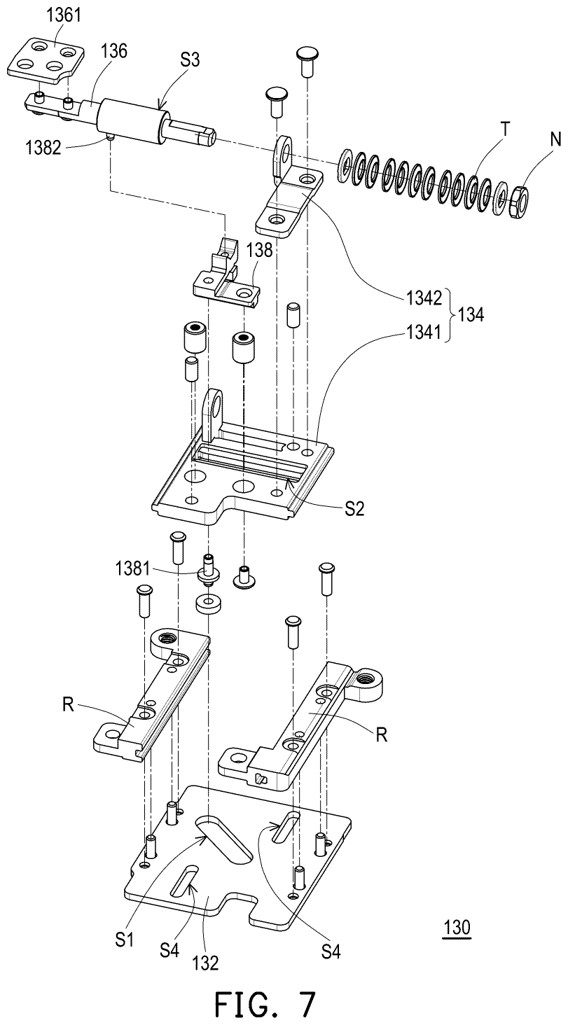

FIG. 4A to FIG. 4D are three-dimensional diagrams of the actuation process of the hinge module of FIG. 2. FIG. 5A to FIG. 5D are three-dimensional diagrams of the hinge module of FIG. 4A to FIG. 4D respectively at different viewing angles. FIG. 6A to FIG. 6D are three-dimensional diagrams of the hinge module of FIG. 4A to FIG. 4D respectively at different viewing angles. FIG. 7 is an exploded diagram of some components of the hinge module of FIG. 2. Referring to FIG. 4A to FIG. 7, specifically, the hinge module 130 of this embodiment includes a base 132, a first sliding member 134, a rotating shaft 136, and a second sliding member 138. The base 132 is disposed on the first body 110 (shown in FIG. 1 to FIG. 3) and has a first guiding slot S1. The first sliding member 134 is slidably disposed on the base 132 along a first axial direction A1 parallel to the direction D1 and has a second guiding slot S2. The rotating shaft 136 is pivotally connected to the first sliding member 134 along a second axial direction A2 perpendicular to the first axial direction A1 and is connected to the second body 120 (shown in FIG. 1 to FIG. 3) through a bracket 1361. The rotating shaft 136 has a third guiding slot S3.

The first guiding slot S1 is inclined to the first axial direction A1 and the second axial direction A2, the second guiding slot S2 is parallel to the second axial direction A2, and the third guiding slot S3 is inclined to the first axial direction A1 and the second axial direction A2. The inclination angle of the first guiding slot SI relative to the first axial direction A1 and the second axial direction A2 is, for example, 45 degrees, but the disclosure is not limited thereto. The second sliding member 138 is directly slidably disposed in the first guiding slot S1, the second guiding slot S2, and the third guiding slot S3. When the second body 120 is flipped relative to the first body 110 as shown in FIG. 2 to FIG. 3 to pivot the rotating shaft 136, the second guiding slot S2 and the third guiding slot S3 guide the second sliding member 138 to move on the first sliding member 134 along the second axial direction A2 as shown in FIG. 4A to FIG. 4D, and the first guiding slot S1 guides the second sliding member 138, the first sliding member 134, the rotating shaft 136 and the second body 120 (shown in FIG. 1) to move together on the base 132 along the first axial direction A1 in the direction D1 toward the front end of the first body 110.

As described above, in the electronic device 100 of this embodiment, the rotating shaft 136 of the hinge module 130 may guide the second sliding member 138 to move along the second axial direction A2 through its inclined third guiding slot S3. When the second sliding member 138 moves along the second axial direction A2, the second sliding member 138, the first sliding member 134, the rotating shaft 136 and the second body 120 may be guided to move on the base 132 along the first axial direction A1 together through the combination of the non-inclined second guiding slot S2 of the first sliding member 134 and the inclined first guiding slot S1 of the base 132. Accordingly, when the user closes the second body 120 to the first body 110, the second body 120 and the hinge module 130 cover the heat dissipation holes of the heat dissipation region 1101 on the first body 110 to prevent dust and other foreign objects from falling into the heat dissipation holes. Furthermore, when the user unfolds the second body 120 relative to the first body 110, the rotating shaft 136 and the second body 120 are displaced to expose the heat dissipation region 1101 on the first body 110, thereby greatly increasing the heat dissipation efficiency of the electronic device 100. Furthermore, in the hinge module 130 of this embodiment, the second sliding member 138 is guided by the third guiding slot S3 of the rotating shaft 136 as described above, and is guided by the combination of the second guiding slot S2 of the first sliding member 134 and the first guiding slot S1 of the base 132, so that the second sliding member 138 is directly connected to the base 132, the first sliding member 134 and the rotating shaft 136 through the first guiding slot S1, the second guiding slot S2 and the third guiding slot S3 respectively, so as to improve the overall actuation stability, wear resistance, actuation accuracy, structural strength and vibration resistance of the hinge module 130.

In detail, the second sliding member 138 of this embodiment has a first sliding portion 1381 (shown in FIG. 6A to FIG. 6D and FIG. 7). The first sliding portion 1381 is slidably disposed in the first guiding slot S1 and the second guiding slot S2, and the second sliding portion 1382 is slidably disposed in the third guiding slot S3. The first sliding portion 1381 is, for example, a columnar latch, but the disclosure is not limited thereto. More specifically, the first guiding slot S1 and the second guiding slot S2 of this embodiment partially overlap as shown in FIG. 6A to FIG. 6D, and the first sliding portion 1381 is disposed at the overlapping portion of the first guiding slot S1 and the second guiding slot S2 in a penetrating way. Accordingly, when the second sliding member 138 moves in the second guiding slot S2 along the second axial direction A2 as shown in FIG. 4A to FIG. 4D, the second sliding member 138 also moves in the first guiding slot S1 and forces the second sliding member 138 to move relative to the base 132 in the first axial direction A1, so that the first sliding member 134 and the rotating shaft 136 move relative to the base 132 in the first axial direction Al along with the second sliding member 138.

In addition, the second sliding member 138 of this embodiment further has a second sliding portion 1382 (shown in FIG. 5A to FIG. 5D and FIG. 7). The second sliding portion 1382 is slidably disposed in the third guiding slot S3. The second sliding portion 1382 is, for example, a columnar latch, but the disclosure is not limited thereto. More specifically, the third guiding slot S3 of this embodiment extends obliquely around the axis of the rotating shaft 136 as shown in FIG. 5A to FIG. 5D, the second sliding portion 1382 is disposed in the third guiding slot S3 in a penetrating way, and the second sliding member 138 is restricted by the second guiding slot S2 to move in the second axial direction A2. Accordingly, when the rotating shaft 136 pivots, the second sliding portion 1382 moves along the third guiding slot S3 and forcibly drives the second sliding member 138 to move in the second axial direction A2. Furthermore, the length of the third guiding slot S3 may be increased as required to achieve a wider range of movement.

In this embodiment, as shown in FIG. 7, the first sliding member 134 includes a sliding member body 1341 and a fixing base 1342 that are assembled with each other. However, the disclosure is not limited thereto, and in other embodiments, the first sliding member 134 may be an integrally formed structure.

The base 132 of this embodiment has at least one fourth guiding slot (two fourth guiding slots S4 are shown in FIG. 6A to FIG. 6D). The fourth guiding slot S4 is parallel to the first axial direction Al, and the first sliding member 134 is slidably disposed in the fourth guiding slot S4. In addition, the hinge module 130 of this embodiment further includes at least one rail (two rails R are shown), and the first sliding member 134 is slidably disposed on the base 132 along the first axial direction A1 through the rail R. Accordingly, the first sliding member 134 may stably move on the base 132 along the first axial direction A1.

In this embodiment, the hinge module 130 further includes at least one torsion element (shown as multiple torsion elements T). The torsion element T is disposed between the rotating shaft 136 and the fixing base 1342 of the first sliding member 134. Specifically, the torsion element T is, for example, an annular torsion spring and is sleeved on the rotating shaft 136, and is pressed against the fixing base 1342 by a fastener N (e.g., a nut) to provide the required torque for the rotating shaft 136.

To sum up, in the electronic device of the embodiment of the disclosure, the rotating shaft of the hinge module may guide the second sliding member to move along the second axial direction through its inclined third guiding slot. When the second sliding member moves along the second axial direction, the second sliding member, the first sliding member, the rotating shaft and the second body may be guided to move on the base along the first axial direction together through the combination of the non-inclined second guiding slot of the first sliding member and the inclined first guiding slot of the base. Accordingly, when the user closes the second body to the first body, the second body and the hinge module cover the heat dissipation holes in the heat dissipation region of the first body to prevent dust and other foreign objects from falling into the heat dissipation holes. Furthermore, when the user unfolds the second body relative to the first body, the rotating shaft and the second body are displaced accordingly to expose the heat dissipation region on the first body, thereby greatly increasing the heat dissipation efficiency of the electronic device. Furthermore, in the hinge module of the embodiment of the disclosure, the second sliding member is guided by the third guiding slot of the rotating shaft as described above, and is guided by the combination of the second guiding slot of the first sliding member and the first guiding slot of the base, so that the second sliding member is directly connected to the base, the first sliding member and the rotating shaft through the first guiding slot, the second guiding slot and the third guiding slot respectively, so as to improve the overall actuation stability, wear resistance, actuation accuracy, structural strength and vibration resistance of the hinge module.

What is claimed is:

1. An electronic device, comprising:
a first body;
a second body; and
a hinge module, comprising a base, a first sliding member, a rotating shaft, and a second sliding member, wherein the base is disposed on the first body and has a first guiding slot, the first sliding member is slidably disposed on the base along a first axial direction and has a second guiding slot, the rotating shaft is pivotally connected to the first sliding member along a second axial direction and is connected to the second body, the rotating shaft has a third guiding slot, the first guiding slot is inclined to the first axial direction and the second axial direction, the second guiding slot is parallel to the second axial direction, the third guiding slot is inclined to the first axial direction and the second axial direction, the second sliding member is slidably disposed in the first guiding slot, the second guiding slot, and the third guiding slot,
when the second body is flipped relative to the first body to pivot the rotating shaft, the second guiding slot and the third guiding slot guide the second sliding member to move on the first sliding member along the second axial direction, and the first guiding slot guides the second sliding member, the first sliding member, the rotating shaft and the second body to move together on the base along the first axial direction.

2. The electronic device according to claim 1, wherein the second sliding member has a first sliding portion and a second sliding portion, the first sliding portion is slidably disposed in the first guiding slot and the second guiding slot, and the second sliding portion is slidably disposed in the third guiding slot.

3. The electronic device according to claim 2, wherein the first guiding slot and the second guiding slot partially overlap each other, and the first sliding portion is disposed at an overlapping portion of the first guiding slot and the second guiding slot in a penetrating way.

4. The electronic device according to claim 1, wherein the first axial direction and the second axial direction are perpendicular to each other.

5. The electronic device according to claim 1, wherein the base has at least one fourth guiding slot, the at least one fourth guiding slot is parallel to the first axial direction, and the first sliding member is slidably disposed in the at least one fourth guiding slot.

6. The electronic device according to claim 1, wherein the hinge module further comprises at least one rail, and the first sliding member is slidably disposed on the base along the first axial direction through the at least one rail.

7. The electronic device according to claim 1, wherein the second sliding member, the first sliding member, the rotating shaft, and the second body are adapted to move together along a direction toward a front end of the first body as the second body is unfolded relative to the first body.

8. The electronic device according to claim 1, wherein an inclination angle of the first guiding slot relative to the first axial direction and the second axial direction is 45 degrees.

9. The electronic device according to claim 1, wherein the first body has at least one heat dissipation region, and the second sliding member, the first sliding member, the rotating shaft, and the second body are adapted to move as the second body is unfolded relative to the first body to expose the at least one heat dissipation region.

10. The electronic device according to claim 1, wherein the hinge module further comprises at least one torsion element, and the at least one torsion element is disposed between the rotating shaft and the first sliding member.
